(19) United States
(12) Patent Application Publication
(10) Pub. No.: US 2010/0038942 A1
(43) Pub. Date: Feb. 18, 2010

(54) Insulating seat cover

(76) Inventor: GREG WATSON, Davie, FL (US)

Correspondence Address: RUBEN ALCOBA, ESQ., 3399 NW 72 AVENUE, SUITE211, MIAMI, FL, 33122, US

(21) Appl. No.: 12/191,005

(22) Filed: Aug. 13, 2008

(51) Int. Cl. B60N 2/60

(52) U.S. Cl. 297/219.12

(57) ABSTRACT

An insulating seat cover that can be securely donned over most seats. The insulating seat cover comprises of an insulating sheet of material and a sleeve that attaches to the insulating material.

### BACKGROUND

The present invention is related to insulating seat covers that prevent car seats from obtaining temperatures that could scald the human body.

The inventor resides in South Florida and realized that he needed to invent an insulating seat cover that could easily be thrown over an automobile seat or a child car seat to prevent the seat from obtaining scalding temperatures. He was familiar with people who would throw a blanket over a car seat to prevent the car seat from reaching uncomfortable temperatures, yet he realized that the people who used this technique usually spent an unwanted amount of time trying to secure the blanket over the seat in order to prevent the blanket from slipping off the seat because of the effects of gravity and the weight of the blanket.

Eventually, most people using the above technique realized that the time it took to secure the blanket did not merit the effort of keeping their seats at a comfortable temperature.

He realized that he had to invent a universal seat cover for automobile seats or child car seats. Knowing that all seats do not have the same measurements, he had to provide users of his insulating seat cover with a manner of allowing them to adjust the cover to fit over their specific seats.

The following are heat reflective seat cover patents or published applications: Samaha, U.S. Pat. No. 6,726,277 B1; Chai et al, U.S. Pat. No. 6,904,923 B2; Arenas, U.S. Pat. No. 6,659,551 B1; Sparks, U.S. Pat. No. 6,648,410; Franklin et al., U.S. Pat. No. 6,382,720 B1; Shikler, U.S. Pat. No. 5,655,810; Bernardo, U.S. Pat. No. 5,114,204; Busso et al., U.S. Pat. No. 4,790,592; Wilson, U.S. Pat. No. 4,458,738; Ricke, U.S. Pat. No. 4,118,066; Compton, Pub. No U.S. 2006/0284456 A1; Billock, Pub. No. U.S. 2007/0102079 A1; and Blackler, Pub. No. U.S. 2003/0057750 A1. All of the above referenced matter pertains to attempts to insulate either automobile seats or child car seats with temporary seat covers. None of the above references provide a universal fitting insulating seat cover that can be secured over most seats by the user.

An object of the present invention is to provide a user of an insulating seat cover with a manner of easily donning the seat cover over the seat that it will cover.

A further object of the present invention is to provide a universal insulating seat cover that will fit over most automobile and child car seats.

Another object of the present invention is to provide an insulating seat cover that will be easily stored and that will not damage the material of permanent automobile seats or child car seats.

For the foregoing reasons, there is a need for an insulating seat cover kit that will temporary cover seats from the extremes of the sun.

### SUMMARY

The present invention is directed to an insulating seat cover that can be securely donned over most seats. The insulating seat cover comprises of an insulating sheet of material and a sleeve that attaches to the insulating material.

### DRAWINGS

These and other features, aspects, and advantages of the present invention will become better understood with regard to the following description, appended claims, and drawings where:

FIG. 1a-1b show a perspective view of an insulating seat cover that is placed over a car seat;

FIG. 2a-2b show a perspective view of an insulating seat cover that is placed over a child car seat;

FIG. 3 shows a top plan view of the insulating sheet of the present invention; and

FIG. 4 shows a bottom plan view of the insulating sheet of the present invention.

### DESCRIPTION

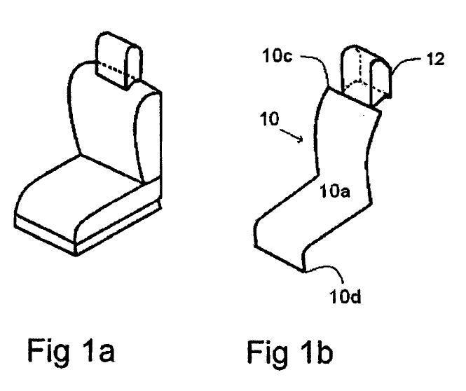

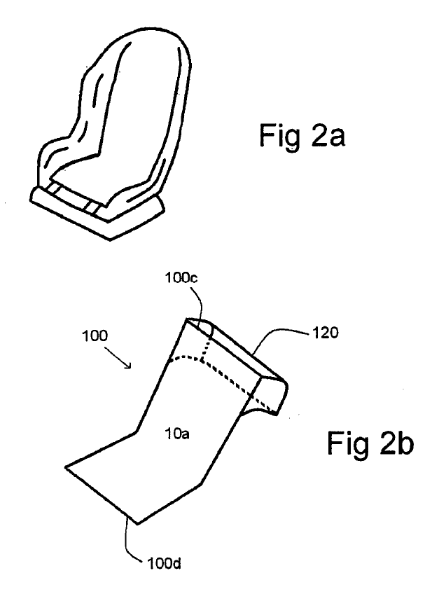

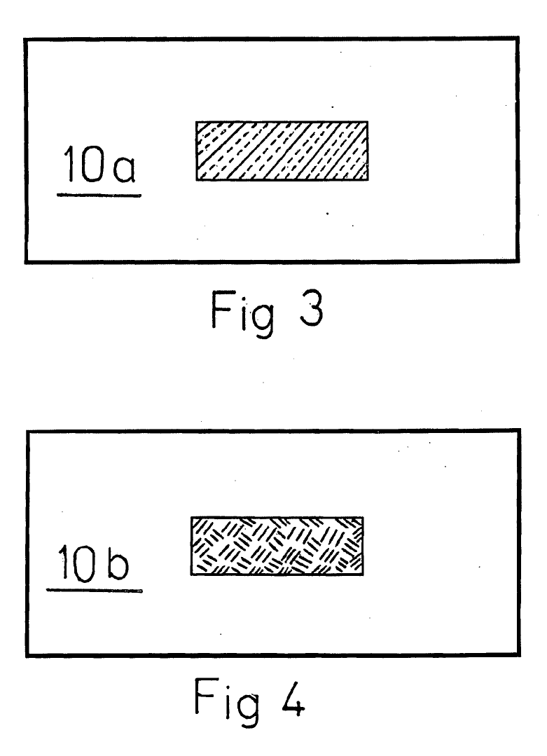

As seen in FIGS. 1a-4, an insulating seat cover comprises an insulating sheet of material 10/100 having a length and width to cover a standard car seat or child car seat, the sheet 10/100 has a top surface 10a, a bottom surface 10b, an upper side 10c/100c, and a lower side 10d/100d. And, a sleeve 12/120, the sleeve attaches to the upper side of the sheet 10c/100c.

The sleeve 12/120 might attach to the sheet 10/100 using hook and loop materials or can be sewn on to the sheet 10/100. It is foreseen that other means of attaching a sleeve to the sheet are foreseen in the art.

In a preferred embodiment of the present invention, the top surface 10a of the insulating sheet 10a/100a is made of insulating material and the bottom surface 10b/100b of the sheet 10/100 is made of a material that has a high coefficient of friction.

In embodiments of the present invention, the insulating material might be wool, a lightweight aluminized fiber, or any other insulating material known in the art of fiber insulation.

In the above embodiments, the insulating sheet 10/100 will be cut to standard dimensions to cover either an automobile seat or a child car seat. It is foreseen that the above embodiment can be used on boats and any other type of outdoor seat.

The above embodiments are used by first providing the insulating seat cover. Then, opening the seat cover so that the sleeve of the insulating seat cover is placed either over the head rest of a car seat or over the top of a child car seat. Next, sliding the sleeve either over the head rest or the top of the child car seat. Lastly, draping the insulating sheet over the car seat or the child car seat so that the material of the car seat or the child car seat is covered.

An advantage of the present invention is that it provides the user of the insulating seat cover with a manner of easily donning the seat cover over the seat that it is to cover.

A further advantage of the present invention is that it provides an insulating seat cover that fits over most automobile and child car seats.

Another advantage of the present invention is that it provides an insulating seat cover that is easily stored and that does not damage material of the seats over which it is placed.

Although the present invention has been described in considerable detail with reference to certain preferred versions thereof, other versions are possible. Therefore the spirit and the scope of the claims should not be limited to the description of the preferred versions contained herein.

1. (canceled)

2. (canceled)

3. (canceled)

4. (canceled)

5. (canceled)

6. (canceled)

7. (canceled)

8. (canceled)

9. (canceled)

10. An apparatus for protecting the seat back and the seat of a vehicle from radical temperature variations, the apparatus comprising: a substantially rectangular insulating sheet of material, said sheet being made of a highly frictional material that grips said upholstery of said vehicle seat to prevent the movement of said sheet when a driver enters said vehicle, the sheet having a seat portion adapted to conform to said seat portion of said vehicle seat of said vehicle, a back portion adapted to conform to said back portion of said vehicle seat of said vehicle, said back portion comprises a sleeve made of insulating material, said sleeve being adapted to cover the top portion of said vehicle seat, said sleeve being attached to said back portion using hook and loop mechanism, wherein said sheet is made from the group selected from wool and lightweight aluminized fiber.
